(19) United States
(12) Patent Application Publication
(10) Pub. No.: US 2026/0328459 A1
(43) Pub. Date: Oct. 22, 2026

(54) THERMOSTABLE SYSTEM FOR COLD CHAIN AND PREPARATION METHOD THEREOF

(71) Applicants: Council of Scientific and Industrial Research, New Delhi (IN); Createcomm Tech Private Limited, Gurugram, Haryana (IN)

(72) Inventors: Rajeshwar Matche, Kamataka (IN); Sachin R. Chaudhri, Kamataka (IN); Samiran Sengupta, Haryana (IN); Suraj P., Kerala (IN); Thillai Natarajan M, Tamil Nadu (IN)

(73) Assignees: Council of Scientific and Industrial Research, New Delhi (IN); Creatcomm Tech Private Limited, Gurugram, Haryana (IN)

(21) Appl. No.: 19/122,049

(22) PCT Filed: Oct. 19, 2023
(86) PCT No.: PCT/IN2023/050963

§ 371 Date: Apr. 17, 2025

(30) Foreign Application Priority Data
Oct. 19, 2022 (IN) 202211059650

(51) Int. Cl. F25D 3/08; C09K 5/10

(52) U.S. Cl. CPC F25D 3/08; C09K 5/10; F25D 2303/0831; F25D 2303/085

(57) ABSTRACT

The present invention discloses a thermostable system (100) for storage and transportation of perishable goods in cold-chains, especially of food items. The said system combines an insulation container (102) made of biodegradable polyurethane with a cooling solution. Given polyurethane's hydrophilic nature and softer texture, a commercially-sourced damp-proof, lightweight, and food-grade coating is applied to the insulation container (102), offering enhanced water-resistance, easier handling, and extended holding-time. The system (100) further comprises a double-walled trough (112) to hold the goods to be stored/transported and the cooling solution can be filled into the hollow spaces between the inner and outer walls of the said trough. The cooling solution consists of 30% w/v Polyethylene Glycol (PEG)-4000 in water and when used in conjunction with the insulation container (102), enable the thermostable system (100) to sustain a 2-15 °C temperature range for 60 to 100 hours.

This Application claims the benefit of Indian Provisional Patent Application 202211059650 filed on Oct. 19, 2022, the entire content of which is hereby incorporated by reference.

### TECHNICAL FIELD OF THE INVENTION

The present invention relates generally to supply chain network, and particularly, but not exclusively, to low temperature-controlled supply chain network, or Cold chain.

### BACKGROUND

A drastic increase in the demand for food and medical supplies all around the globe over the past few decades has led to the spread of storage facilities, temperature-controlled environments and cold supply chains to provide people with their daily needs. Despite a significant growth in the technical and infrastructural advancement of the cold supply chain domain, there remain several aspects in the domain with shortcomings that need to be addressed. Packaging is one such aspect. Packaging plays a vital role in a supply chain network and it is important to choose the right packaging materials and processes to ensure the freshness and safety of products. The present invention is concerned with the packaging for storage and shipping of goods, especially Perishable Food Products (PFPs), for cold chain.

PFPs like fruits and vegetables, constitute about 70% of the total wasted food (Gardas et al., 2018). Wastage of PFPs incur the loss of an enormous number of natural resources; as a result, large amounts of resources that go into the production, transportation, and marketing of these food products gets wasted (Sgarbossa and Russo, 2017). Owing to the perishable nature of products and limited shelf life, management of sustainability in PFSCs is critical. Perishable food supply chains (PFSCs) are characterized with rising food quality and safety concerns, alarming food wastages and losses, and poor economic sustainability. Other factors like shortage or absence of electricity, poor infrastructure, and poor connectivity etc. cause unexpected delays in delivery and consequent loss of shelf life of the products. To mitigate such issues, thermostable systems came into existence.

Some of the commercially available thermostable systems utilize polystyrene, polyethylene, polyvinyl chloride, polypropylene, or polyethylene terephthalate based insulating material to prepare the thermostable containers. However, these materials pose disposal and recycling limitations and are unsafe to use. Polystyrene foam, for example, is a potential human carcinogen and Polyvinyl chloride contains potentially harmful chemical additions such as phthalates, lead, cadmium, and organotin, which are harmful to human health.

Thus, due to its several beneficial features as compared to the above-mentioned materials, polyurethane makes a great choice as a material for preparation of thermostable containers. The polyurethane containers are particularly cost-effective in production and maintenance in the food delivery sector. They are also suited for long-distance food transportation due to their lightweight nature. Furthermore, the Polyurethanes are non-toxic to the environment as they break down and do not contain any toxic chemicals which can interfere with endocrine systems. Thus, the biodegradability and non-toxic nature of the polyurethanes makes it an eco-friendly alternative to the other harmful options.

However, the polyurethanes have certain shortcomings of their own. One of the main disadvantages of polyurethane is its hydrophilic nature, which increases the risk of food spoilage. Another major disadvantage is that it is a very soft material and is thus difficult to handle or transport. To overcome these obstacles, some manufacturers cover the polyurethane with HDPE or PET-based water-resistant polymer or some other coating. But the process makes the container non-biodegradable and also increases its weight, consequently increasing the cost and decreasing the ease of transportation. Prior arts CN206289853U and CN101435254A disclose such processes. The present invention aims to resolve this problem by coating the polyurethane insulation container with layers of commercially-sourced lightweight, damp-proof, and food grade coating. Thus, the coated containers remain lightweight and non-toxic and are rendered water-resistant.

Besides insulation container, another important part of the thermostable systems are the cooling pads/pouches that help maintain the cold temperature inside the insulation containers. Most of reported cooling pads' temperature ranges are below −15 °C, such as those disclosed by prior arts U.S. Pat. No. 4,206,101A and U.S. Pat. No. 7,5683,59B, making them unsuitable for perishable goods, grains, and sweets etc. In other cases, the refrigerant used in cooling pads are unsafe to use. Prior arts US20150130335A1 and US20100314397A1 disclose refrigerants Polyethylene glycol solution and PEG (365) in water respectively, both of which are toxic in nature due to the mixing of inorganic chemicals. To overcome the above-mentioned problems, the present invention proposes the use of PEG-4000, which is non-toxic in nature, in varying concentrations to achieve temperature ranges of 2-15 °C, which is ideal for perishable food products.

### OBJECTS OF THE PRESENT DISCLOSURE

Some of the objects of the present disclosure, which at least one embodiment herein satisfies are as listed herein below.

The principal object of the present invention is to provide an improved thermostable system for cold supply chain.

Another object of the present invention is to ease the handling and transportation process in cold chain by offering a lightweight thermostable container.

Another object of the present invention is to offer an improved holding time of goods in the cold chain.

Another object of the present invention is to provide a wider range of temperature for storage and/or shipping of goods in the cold chain.

Another object of the present invention is to provide a sustainable thermostable container that is also cost-effective.

Yet another object of the present invention is to enhance customer safety by offering a food-grade and non-toxic thermostable container.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The thermostable system disclosed by the present invention combines an insulation container with a cooling solution for storage and/or shipping of, mainly, but not limited to, perishable food items. In the present invention, polyurethane has been used as the insulating material for construction of the insulation containers. Polyurethane is a biodegradable material and is safe for storage of food. Furthermore, polyurethane has a lesser heat transfer rate as compared to thermostable containers made of other materials. However, there are two significant drawbacks with using polyurethane; firstly, it is hydrophilic in nature, which increases the risk of food spoilage, and secondly, polyurethane is a soft material, which makes its handling difficult. To overcome these drawbacks, the present invention makes use of a commercially-sourced damp-proof coating to coat the polyurethane container. The said coating is light in weight and food-grade. The coating process not only makes the container water-resistant and easier to handle, it also increases the holding time of the container by providing additional insultation.

To hold the goods inside the containers at low temperature, a double-walled trough has been designed. The said trough is provided with a hole on the top surface of one of its sides through which the cooling solution can be filled into it. The trough is also equipped with collapsible handles for easy its placement inside the container and for an easier handling otherwise as well.

The method disclosed by the present invention for preparation of the above-mentioned cooling solution includes dissolving Polyethylene Glycol (PEG)-4000 in water at a concentration of 30% w/v. To use the cooling solution in combination with the insulation containers, the solution needs to be frozen to −5 °C for 24 hours, then thawed to −2 °C, before being dispensed into the said trough. Alternatively, the cooling solution can be sealed within PET-PE pouches to form cooling pads.

Another distinct feature of the present invention is the temperature display system, consisting of a temperature sensor with a 1 square-inch display that displays the cooling solution's temperature. The sensor is connected with the cooling solution by means of a wire that can be inserted into the trough through the trough-hole. According to the preferred embodiment, the same hole that is used for filling the cooling solution, can be used for inserting the temperature sensor's wire into the trough. The advantage of connecting the temperature sensor with the cooling solution instead of connecting it directly with the goods stored in the trough avoids direct contact of the wire with the goods and this is especially more desirable when the goods to be stored/shipped are food items as the food items are highly susceptible to contamination.

Technical advantages of the invention include the system's ability to maintain temperatures as low as −18 °C, to hold a temperature range between 2-15 °C, which is a recommended range for perishable food products, and to achieve holding durations between 60 to 100 hours.

In practical applications, the system ensures that stored food items retain their quality attributes, including taste and texture. Beyond standard perishable items, the system can be used for storing and transporting various other goods, including rice-based items, ice cream packs, meals for eateries, and designer ice cubes. The invention is also suitable for areas with limited electricity, demonstrating its versatility and wide range of use cases.

### BRIEF DESCRIPTION OF THE DRAWINGS

The drawings described herein are for illustrative purposes only of selected embodiments, and are not intended to limit the scope of the present disclosure. The present invention will hereinafter be described in conjunction with the following drawing figures, wherein like numerals denote like elements, and wherein:

FIG. 1 represents front view of the thermostable system 100, where
102—Insulation container (Cold box);
104—Lid of the insulation container;
106—Steel latches; &
108—Sensor display.

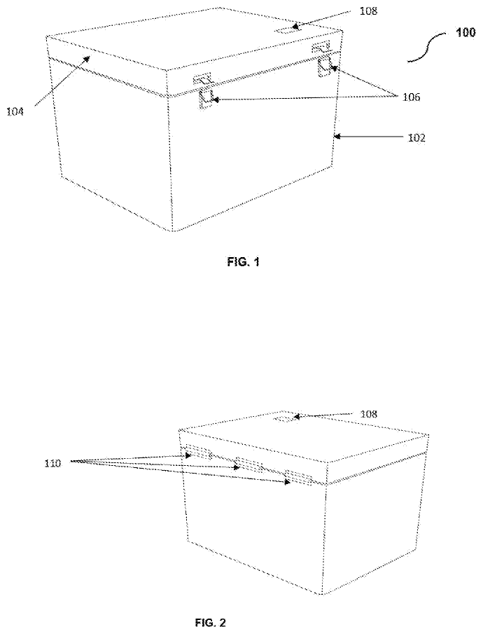

FIG. 2 represents back side view of the thermostable system 100, where
110—Hinges.

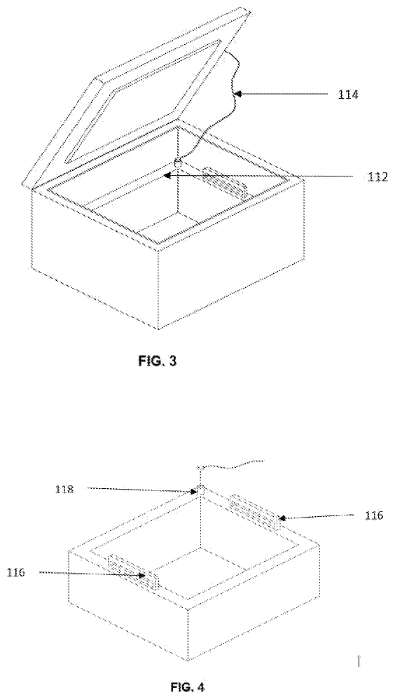

FIG. 3 represents an open thermostable system 100, where
112—Trough;
114—Wire;
116—Handles; and
118—Trough-hole.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

As used herein, the term “cooling solution” is used to refer to an aqueous solution of Polyethylene Glycol (PEG)-4000, which is a phase change material (PCM).

The terms “Insulation container” or “Cold box” have been used interchangeably throughout the description.

Referring now to FIGS. 1-4, FIG. 1 in an exemplary embodiment represents a thermostable system 100 proposed by the present invention. The thermostable system 100 broadly comprises an insulation container/cold box 102 and a trough 112.

The container 102 has a top lid 104 with a sensor display 108 on its upper surface; the lid 104 is fastened to the backside of the container 102 by means of hinges 110, as shown in FIG. 2, and is provided with latches 106 on the front side for opening and closing purposes. The latches 106 are made preferably of steel and contain springs to offer better locking and sturdiness. The hinges 110 are provided on the outer side of the container 102 to have a smooth opening-closure. Placement of hinges on inner side of box leads to hard opening-closure of the lid.

FIG. 3 & FIG. 4 in an embodiment proposed by the present invention, represent the thermostable system 100 with a trough 112 for storing the goods to be maintained at low temperatures. The trough 112 is a double-walled container with a hollow space between the inner and the outer walls and is equipped with a pair of handles 116 for easy handling. According to the preferred embodiment, the handles 116 are collapsible. The trough is designed to have a hole 118, referred to as the trough-hole hereinafter, on its top surface which can be used for filling of the cooling solution into its hollow spaces. Once, the trough 112 is filled with the cooling solution and is placed inside the cold-box 102, the wire 114 from the sensor display 108 can be connected to the cooling solution through this trough-hole 118 for monitoring the temperature of the cooling solution.

According the preferred embodiment, the insulation container 102 is made up of polyurethane and the method for its preparation broadly comprises: designing the required volume of the container based on the quantity of material required for storage/transportation, cutting accordingly, and thereafter coating all the surfaces of the container with one or more layers of a commercially-sourced damp-proof coating to curb the side-effects of the hydrophilic nature of polyurethane. The coating process not only makes the container 102 water-resistant but also adds an additional insulation layer to it, thus imparting extra holding-time to the containers. In an embodiment, the thickness of the insulating material is minimum 50 mm, and the thickness of damp-proof coating is 4 mm.

The method for preparing the cooling solution, as proposed by the present invention, comprises dissolving Polyethylene Glycol (PEG)-4000 in water with the preferred concentration of the aqueous PEG-4000 solution being 30% w/v. To use the cooling solution for storage/transportation of goods, it must first be frozen at −5 °C for 24 hours and then thawed to bring its temperature to −2 °C before filling it into the trough 112. The said solution is dispensed into the trough 112 through the trough-hole 118 till the space between the inner and outer wall of the double-walled trough is filled.

In another preferred exemplary embodiment, the cooling solution was filled into cooling pads to be used in other applications for low temperature storage of goods. The cooling pads were prepared by heat-sealing a 1-liter cooling solution, that was prepared by dissolving 30 grams of PEG-4000 in 1 liter of distilled water, in polyethyleneterephthalate-polyethylene (PET-PE) pouches. (The volume of the solution required depends on the weight of the food required for the transportation, the weight to volume ratio should be 1:1). The cooling pads were frozen at −5 °C for 24 hours and then brought back to −2 °C before storing in the insulation container 102.

The dimensions of the insulation container 102 and the concentration of PEG-4000 can be customized according to weight, volume and temperature requirements of the goods to be stored/shipped.

The technical advantage of the invention is presented in the form of experimental results as given below:

The present invention preferably uses Polyurethane Foam (PUF) as the insulation material for the thermostable system 100.

The temperature monitoring of the cooling solution being displayed on the sensor display 108 showed reduced risk of food contamination as compared to sensors which monitored the temperature of food products. This is because measurement of food temperature needs contact of sensor and food which may lead to unhygienic process as well as challenges in placement of sensor on food. The arrangement of the components of the present invention overcame this drawback.

In addition, the sensor display has a size of 1 square inch which constantly displays temperature during the transit or storage period. The display operates on battery supply which can be replaced after couple of months during maintenance. No charging circuit is required due to replaceable battery.

Engineered to excel in extreme cold conditions, the thermostable system 100 of the present invention ensures that food remains consistently frozen at temperatures as low as −18 degrees Celsius, with the ability to uphold these freezing temperatures over extended periods. By using the combination of coated polyurethane container with the PEG-4000 cooling solution, temperature range of 2-15 °C and holding time of 60 to 100 hours was achieved. Various thicknesses of the container and concentrations of the PEG-4000 solution were tested to achieve varying temperature ranges and holding times.

Using the thermostable system 100, as set forth by the present invention, with food products, it was observed that the food products remained intact in their quality, without a loss of aroma, taste, or texture. Storage of food items at extremely low temperatures i.e., less than 0 °C and more than 8 °C was not desired as it led to loss of taste & texture, and frequent spoilage of food was observed due to freeze-thaw cycles.

The manufacturing costs of the containers used in present invention were observed to be lower than the other commercially available containers.

The thermostable system 100 disclosed by the present invention combines an insulation container 102 with cooling solution (aqueous PEG-4000) for storage and/or shipping of, mainly, but not limited to, perishable food items. In the present invention, polyurethane has been used as the insulating material for construction of the insulation containers. Polyurethane is a biodegradable material and is safe for storage of food. Furthermore, polyurethane has a lesser heat transfer rate as compared to thermostable containers made of other materials. However, there are two significant drawbacks with using polyurethane; firstly, it is hydrophilic in nature, which increases the risk of food spoilage, and secondly, polyurethane is a soft material, which makes its handling difficult. To overcome these drawbacks, the present invention makes use of a commercially-sourced damp-proof coating to coat the polyurethane container. The said coating is light in weight and food-grade. The coating process not only makes the container water-resistant and easier to handle, it also increases the holding time of the container by providing additional insulation.

The most efficient form of the invention was observed with polyurethane coated with damp-proof coating being used for all the insulating parts of container as compared to other the containers available in the market which are made using polystyrene, polyethylene, polyvinyl chloride, polypropylene, or polyethylene terephthalate.

The insulating material of the containers was found to be light weight and easily biodegradable which made it convenient for storage, transport, and disposal after use, respectively.

The preferred dimensions of the thermostable system 100 are given below:

The dimensions (Length×Width×height in centimeters) as required for a storage volume of 8 L in the trough are:
External size of the insulation container 102 (L×W×H in cm): 54.2×42.7×40
Internal size of the insulation container 102 (L×W×H in cm) with the detachable trough removed: 43×31.5×29
Internal size of the trough 112 (L×W×H in cm): 35.4×23.9×22.4.

The best results for storage in the desired temperature range were observed when the preferred concentration of the aqueous PEG-4000 solution was kept at 30% w/v.

Besides storage/shipping of perishables food items—meat, poultry, fish, milk, eggs, many raw fruits and vegetables, and cooked food etc.—the present invention has multiple other use cases, such as:
Storage and transportation of rice-based materials, ice creams packs, sweets, milk and dairy products, water pouches etc.
Storage and delivery of Hot/Cold meals for restaurants, railway canteens, cafeterias etc.
Storage and delivery of designer ice cubes for restaurants, bars, pubs & night-clubs etc.
Storage utility for street hawkers, venders etc.
Storage solution for areas with scarce or no electricity such as areas and beaches.

While at least one exemplary embodiment has been presented in the foregoing detailed description, it should be appreciated that a vast number of variations exist. It should be understood that various changes can be made in the function and arrangement of elements without departing from the scope of the invention as set forth in the appended claims and the legal equivalents thereof.

1. A thermostable system for cold-chain comprising:
an insulation container for storage and shipment of goods at low temperature ranges, wherein the said container is made up of polyurethane and is coated with at least one layer of a damp-proof coating;
a double-walled trough, having at least one trough-hole on the top surface of one of its side, to hold the goods to be stored/shipped, wherein the trough is designed such that it can be placed inside the said insulation container;
a cooling situation prepared by dissolving Polyethylene Glycol (PEG)-4000 in water, to offer the low temperature ranges required for storing and/or shipment of the goods.

2. The thermostable system as claimed in claim 1, wherein the said cooling solution is filled into the trough via the trough-hole.

3. The thermostable system as claimed in claim 1, wherein the trough is designed to have collapsible handles on the top of two of its sides opposite to each other.

4. The thermostable system as claimed in claim 1, wherein concentration of the PEG-4000 in the cooling solution is 30 grams per liter of water.

5. The thermostable system as claimed in claim 1, wherein the insulation container has a top lid fastened to it by means of a plurality of hinges and wherein the said lid can be opened or closed using one or more latches provided on the front sides of the lid 104 and the insulation container.

6. The thermostable system as claimed in claim 5, wherein the lid is equipped with a sensor display screen to display the current temperatures of the cooling solution by connecting with the cooling system via a wire, wherein the said wire is inserted into the trough through the trough-hole.

7. The thermostable system as claimed in claim 1, wherein the insulation container has a wall-thickness of 50 mm.

8. The thermostable system as claimed in claim 1, wherein the damp-proof coating is a commercially sourced lightweight and food-grade coating.

9. The thermostable system as claimed in claim 1, wherein a temperature range of 2 °C to 15 °C is maintained inside the insulation container 102 for a period of 60 to 100 hours.

10. A method for preparing a thermostable system for cold-chain comprising:
making insulation container with polyurethane;
coating all the surfaces of the said container with at least one layer of a damp-proof coating to make the insulation container water-resistant and sturdy;
preparing a cooling solution by dissolving polyethylene glycol (PEG)-4000 in water with a concentration of 30% w/v;
freezing the said cooling solution at −5 °C for 24 hours and then thawing it to bring its temperature to −2 °C, thereafter filling it between the outer and inner walls of a double-walled trough;
placing the trough filled with the cooling solution inside the insulation container;
wherein a temperature range of 2 °C to 15 °C can be maintained inside the insulation container for a period of 60 to 100 hours.
